(19) United States
(12) Patent Application Publication
(10) Pub. No.: US 2019/0306592 A1
(43) Pub. Date: Oct. 3, 2019

(54) WIRELESS SATELLITE SENSOR

(71) Applicant: VEONEER US INC., Southfield, MI (US)

(72) Inventors: Jacob Pusheck, West Bloomfield, MI (US); Ankur Doshi, Canton, MI (US)

(21) Appl. No.: 15/939,875

(22) Filed: Mar. 29, 2018

(51) Int. Cl. H04Q 9/00

(52) U.S. Cl. CPC H04Q 9/00; H04Q 2209/43

(57) ABSTRACT

A system including a plurality of sensors and a control unit. The plurality of sensors may each comprise a communication device and be configured to monitor information corresponding to a vehicle, generate data signals in response to the information and communicate the data signals. The control unit may be configured to receive the data signals from each of the sensors, interpret the data signals, determine a corrective measure in response to the data signals and generate output signals. The communication device may implement wireless communication. The control unit may receive the data signals wirelessly. The wireless communication may enable the control unit to receive the data signals from the plurality of sensors asynchronously.

### FIELD OF THE INVENTION

The invention relates to vehicle sensors generally and, more particularly, to a method and/or apparatus for implementing a wireless satellite sensor.

### BACKGROUND

Vehicle systems rely on input data acquired from vehicle sensors to make decisions. As vehicle systems become more advanced, and more autonomous decisions are being made by the vehicle, electronic control units need fast and reliable access to sensor data. Conventional data transmission in vehicles uses a wired communication standard, Peripheral Sensor Interface 5 (PSI5), to transfer sensor data to electronic control units.

Wired communication standards, such as PSI5, involve long wires and complex routing. Wires can be 1 m-10 m long and add a significant amount of weight to the vehicle. Long wire bundles also create electromagnetic crosstalk, which compromises data integrity. Since cables are of differing lengths, conditioning circuitry is needed to counter data skew, which increases power consumption (i.e., a constant 25 mA loop for each sensor). Electronic control units also need to have input pins for each sensor, which increases complexity as more sensors are added. Wired communication standards modulate data over power lines, which limits sampling rates. Data transfers are initiated by the electronic control units and data transfer rates are limited. Sensor data is received in allocated time slots, which limits the firing time for deploying restraint systems as corrective measures.

It would be desirable to implement a wireless satellite sensor.

### SUMMARY

The invention concerns a system comprising a plurality of sensors and a control unit. The plurality of sensors may each comprise a communication device and be configured to monitor information corresponding to a vehicle, generate data signals in response to the information and communicate the data signals. The control unit may be configured to receive the data signals from each of the sensors, interpret the data signals, determine a corrective measure in response to the data signals and generate output signals. The communication device may implement wireless communication. The control unit may receive the data signals wirelessly. The wireless communication may enable the control unit to receive the data signals from the plurality of sensors asynchronously.

### BRIEF DESCRIPTION OF THE FIGURES

Embodiments of the invention will be apparent from the following detailed description and the appended claims and drawings in which:

FIG. 1 is a diagram illustrating a context of the invention;

FIG. 2 is a block diagram illustrating an example embodiment of the invention;

FIG. 3 is a block diagram illustrating a control unit communicating with actuators;

FIG. 4 is a block diagram illustrating a multi-channel input for control units;

FIG. 5 is a block diagram illustrating a redundant sensor implementation;

FIG. 6 is a flow diagram illustrating a method for firing a corrective measure as soon as sufficient sensor data is received;

FIG. 7 is a flow diagram illustrating a method for disabling a malfunctioning sensor; and

FIG. 8 is a flow diagram illustrating a method for communicating with control units of other vehicles.

### DETAILED DESCRIPTION OF THE EMBODIMENTS

Embodiments of the present invention include providing a wireless satellite sensor that may (i) enable increased data transfer rates, (ii) reduce power consumption, (iii) separate data communication and power supply, (iv) enable redundant sensor systems, (v) enable sensors to initiate data transfers, (vi) reduce wiring weight and complexity in vehicles, (vii) enable asynchronous sensor data communication, (viii) improve data integrity by eliminating crosstalk and/or (ix) be implemented as one or more integrated circuits.

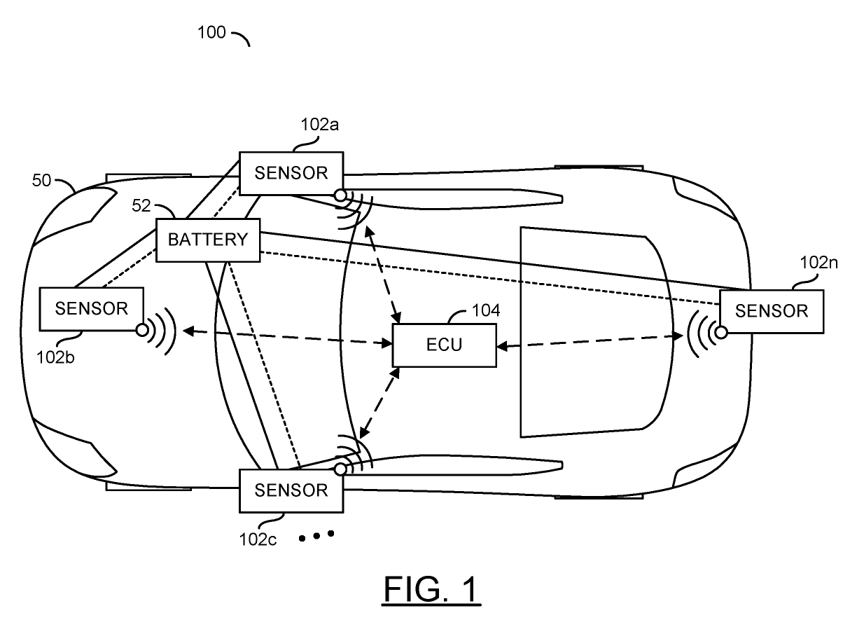

Referring to FIG. 1, a diagram illustrating a context of the invention is shown. A system 100 is shown. The system 100 may be implemented as part of and/or within a vehicle 50. The system 100 may be configured to enable wireless communication of sensor data.

The system 100 may comprise a block (or circuit) 52, a blocks (or circuits) 102a-102n and/or a block (or circuit) 104. The block 52 may implement a battery. The circuits 102a-102n may implement vehicle sensors. The circuit 104 may implement an electronic control unit. The system 100 may comprise other components (not shown). The number, type and/or arrangement of the components of the system 100 may be varied according to the design criteria of a particular implementation.

The battery 52 may be implemented as a conventional car battery of the vehicle 50. In the example shown, the battery 52 may be located under the hood of the vehicle 50. In one example, the battery 52 may be implemented as a 12V lead-acid battery. In another example, the battery 52 may be implemented as a lithium-ion type battery. The battery 52 (and a power distribution system) may be configured to provide power to the components of the vehicle 50. The location, type, electrical characteristics and/or capacity of the battery 52 may be varied according to the design criteria of a particular implementation.

The sensors 102a-102n may be configured to detect, read, sense, and/or receive input. In some embodiments, each of the sensors 102a-102n may be configured to detect a different type of input. In some embodiments, each of the sensors 102a-102n may be the same type of sensor. In one example, the sensors 102a-102n may comprise video cameras (e.g., capable of recording video and/or audio). In another example, the sensors 102a-102n may comprise infrared (IR) sensors (e.g., capable of detecting various wavelengths of light). In some embodiments, the sensors 102a-102n may comprise vehicle sensors (e.g., speed sensors, vibration sensors, triaxial sensors, magnetometers, temperature sensors, gyroscopes, LIDAR, radar, accelerometers, inertial sensors, kinematic sensors, ultrasonic sensors, etc.). For example, the sensors 102a-102n may be configured to detect acceleration in an X direction (e.g., aX), acceleration in a Y direction (e.g., aY), acceleration in a Z direction (e.g., aZ), a yaw, a pitch and/or and roll. The implementation, type and/or arrangement of the sensors 102a-102n may be varied according to the design criteria of a particular implementation.

The sensors 102a-102n may be configured to capture information from the environment surrounding the vehicle 50. The sensors 102a-102n may implement satellite sensors (e.g., sensors implemented around a periphery of the vehicle 50). In some embodiments, the sensors 102a-102n may implement remote sensing units (RSUs). The sensors 102a-102n may be vehicle sensors (e.g., speedometer, fluid sensors, temperature sensors, etc.). In some embodiments, data from the sensors 102a-102n may be used to acquire data used to implement dead reckoning positioning. In one example, the sensors 102a-102n may be various types of sensors configured to determine vehicle movement (e.g., magnetometers, accelerometers, wheel click sensors, vehicle speed sensors, gyroscopes, pressure sensors, etc.). In another example, data from the sensors 102a-102n may be used to determine distances and/or directions traveled from a reference point.

The electronic control unit (ECU) 104 may be configured to receive input (e.g., sensor data and/or sensor readings) from one or more of the sensors 102a-102n. The electronic control unit 104 may be an embedded system configured to manage and/or control different electrical functions of the vehicle 50. The electronic control unit 104 may be configured to interpret the sensor data from the sensors 102a-102n. In an example, interpreting the sensor data may enable the electronic control unit 104 to create a data model representing what is happening near the vehicle 50, within the vehicle 50 and/or to one or more of the components of the vehicle 50. Interpreting the sensor data may enable the electronic control unit 104 to understand the environment and/or make evidence-based decisions.

In the example shown, only one electronic control unit 104 is shown (e.g., as a representative example, for clarity). In some embodiments, multiple types of electronic control units 104 may be implemented. For example, the electronic control units 104 may comprise an Engine Control Module (ECM), a Powertrain Control Module (PCM), a Brake Control Module (BCM), a General Electric

Module (GEM), a Transmission Control Module (TCM), a Central Control Module (CCM), a Central Timing Module (CTM), a Body Control Module (BCM), a Suspension Control Module (SCM), Airbag Control Unit (ACU), Safety Diagnostic Module (SDM), Restraint Control Module (RCM), etc. The number and/or types of electronic control modules 104 may be varied according to the design criteria of a particular implementation.

In some embodiments, the electronic control unit 104 may determine one or more corrective measures in response to the data model generated in response to the sensor data. In one example, the corrective measures implemented by the Engine control module (ECM) electronic control unit 104 may control fuel injection, ignition timing, engine timing and/or interrupt operation of an air conditioning system in response to sensor data from the sensors 102a-102n (e.g., engine coolant temperature, air flow, pressure, etc.). In another example, corrective measures implemented by the electronic control unit 104 may control air bag deployment in response to inertial, impact and/or proximity sensor data by monitoring the sensors 102a-102n. In yet another example, corrective measures implemented by the electronic control unit 104 may comprise activating a warning light (e.g., check engine, coolant temperature warning, oil pressure warning, ABS indicator, gas cap warning, traction control indicator, air bag fault, etc.). The number, type and/or thresholds for sensor data used to initiate the corrective measures may be varied according to the design criteria of a particular implementation.

Connections are shown between the battery 52 and each of the sensors 102a-102n. In the example shown, there may be two connections between the battery 52 and each of the sensors 102a-102n (e.g., supply and ground). In another example, only one connection (e.g., supply) may be implemented between the battery 52 and one or more of the sensors 102a-102n. In the system 100, the connection may not carry data (e.g., a power only connection). In the system 100, the sensors 102a-102n may not receive power from the ECU 104. In the example shown, a direct connection is shown between the battery 52 and each of the sensors 102a-102n for illustrative purposes. However, the sensors 102a-102n may not connect directly to the battery 52.

Each of the sensors 102a-102n may be configured to communicate wirelessly. The sensors 102a-102n are shown communicating wirelessly with the electronic control unit 104. Each of the sensors 102a-102n may monitor information (e.g., the sensor data) corresponding to the vehicle 50. The sensors 102a-102n may wirelessly communicate the sensor data to the electronic control unit 104. Each of the sensors 102a-102n may comprise a wired connection to receive a power supply and a wireless connection to transfer the sensor data.

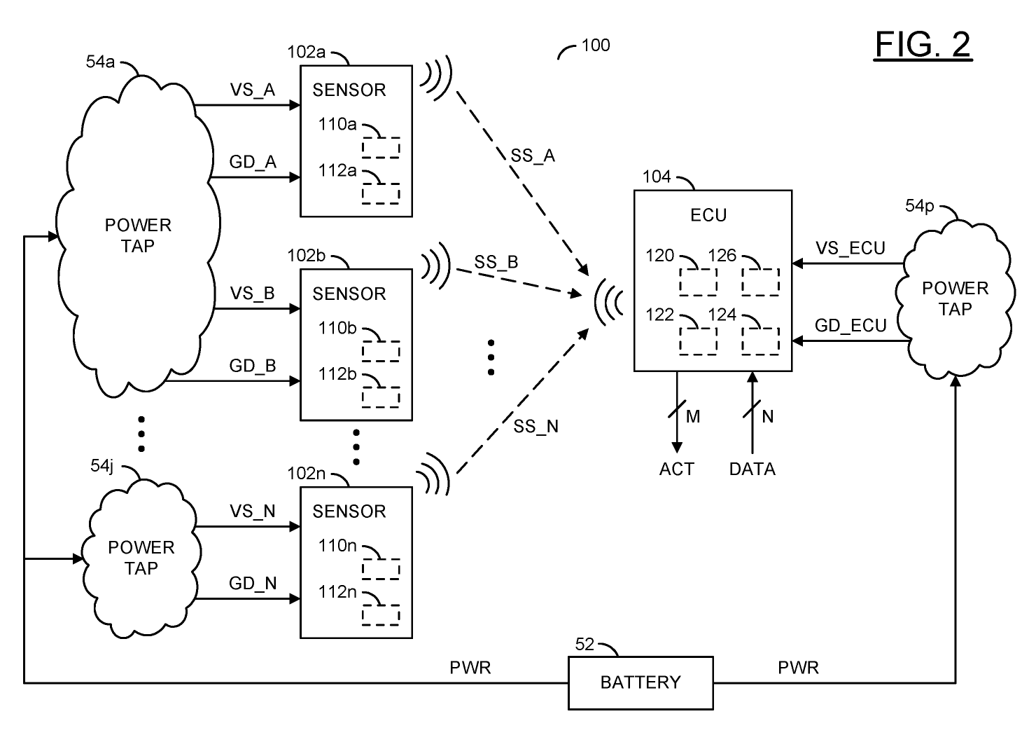

Referring to FIG. 2, a block diagram illustrating an example embodiment of the system 100 is shown. The system 100 may comprise the battery 52, blocks 54a-54p, the sensors 102a-102n and/or the ECU 104. The blocks 54a-54p may be power taps. The system 100 may be implemented within the vehicle 50.

The battery 52 may present a signal (e.g., PWR) to the power taps 54a-54p. The signal PWR may comprise a power supply. The signal PWR may be representative of various voltage levels, current levels and/or connections. For example, a wire, or group of wires, may deliver the signal PWR from the battery 52 to an area of the vehicle 50.

The power taps 54a-54p may represent various sources and/or areas of the vehicle 50 that components may tap into to receive power. In an example, the power taps 54a-54p may represent power interfaces and/or panels. Various components of the vehicle 50 may tap into one or more of the power taps 54a-54p. For example, one of the power taps 54a-54p may service many components of the vehicle 50. The power taps 54a-54p may provide convenience and/or reduce an amount of wiring and/or a length of wire runs.

For example, a component of the vehicle 50 may tap into a nearest and/or accessible one of the power taps 54a-54p.

Each of the sensors 102a-102n may comprise a corresponding block (or circuit) 110a-110n and/or a corresponding block (or circuit) 112a-112n. The circuits 110a-110n may implement an antenna. The circuits 112a-112n may implement communication devices. In an example, the circuits 112a-112n may be wireless communication devices. Each of the sensors 102a-102n may receive a corresponding signal (e.g., VS_A-VS_N) and/or a corresponding signal (e.g., GD_A-GD_N). Each of the sensors 102a-102n may present a corresponding signal (e.g., SS_A-SS_N). The sensors 102a-102n may comprise other components and/or signals (e.g., not shown). The number, type, arrangement and/or implementation of the other components and/or signals of the sensors 102a-102n may be varied according to the design criteria of a particular implementation.

The signals VS_A-VS_N may be voltage supplies for the sensors 102a-102n. The signals GD_A-GD_N may be ground connections for the sensors 102a-102n. The signals VS_A-VS_N and/or the signals GD_A-GD_N may be received from the power taps 54a-54p. A wired connection may be implemented between the sensors 102a-102n and the power taps 54a-54p to transfer the signals VS_A-VS_N. A wired connection may be implemented between the sensors 102a-102n and the power taps 54a-54p to transfer the signals GD_A-GD_N. Generally, the sensors 102a-102n may comprise two wired connections to receive power.

Each of the sensors 102a-102n may connect to a nearest and/or most convenient one of the power taps 54a-54p. For example, a nearby one of the power taps 54a-54p may be selected to tap into to reduce a length of cabling and/or to provide efficient (or accessible) cable routing. In some embodiments, more than one of the sensors 102a-102n may tap into the same one of the power taps 54a-54p. In the example shown, both the sensor 102a and the sensor 102b may each receive the respective signals VS_A-VS_B and GD_A-GD_B from the same power tap 54a. In conventional wired systems, sensors may connect directly to the electronic control unit, which increases the length and weight of cabling of the vehicle. The system 100 may enable shorter cable lengths by implementing wired connections to the power taps 54a-54p to supply power to the sensors 102a-102n.

The signals SS_A-SS_N may be the sensor data generated by the respective sensors 102a-102n. The sensor data signals SS_A-SS_N are shown being communicated wirelessly. The signals SS_A-SS_N may be communicated to the electronic control unit 104.

Implementing the wireless communication for the sensors 102a-102n may enable the sensor data (e.g., SS_A-SS_N) to be communicated separately from the power supply (e.g., the signals VS_A-VS_N and/or the signals GD_A-GD_N). Separating the sensor data from the power supply may prevent crosstalk on the cables and/or ensure data integrity when communicating the sensor data SS_A-SS_N. Separating the sensor data from the power supply may enable a reduction in cabling by enabling the sensors 102a-102n to receive the power supply from a nearby one of the power taps 54a-54p instead of connecting to the ECU 104 to receive power and communicate data.

Separating the sensor data from the power supply may enable the sensor data SS_A-SS_N to be communicated asynchronously (e.g., signal modulation is not needed on the power lines to extract the sensor data). Separating the sensor data from the power supply may enable an increased data transfer rate (e.g., the sensor data communication rate is not restricted by the modulation used to extract the sensor data on the power lines). In an example, the data transfer rate using a wired connection under the PSI5 protocol may be approximately 2 kHz. In an example implementing the system 100, the wireless sensor data SS_A-SS_N may be transferred at a rate of approximately 2 MHz.

The antennas 110a-110n may be configured to communicate wirelessly. For example, the antennas 110a-110n may communicate the signals SS_A-SS_N. The antennas 110a-110n and/or the wireless communication devices 112a-112n may be configured to implement the wireless communication. The wireless communication devices 112a-112n may be configured to generate the signals SS_A-SS_N to provide the sensor data according to one or more wireless protocols. The wireless communication devices 112a-112n may be configured to packetize the sensor data and the antennas 110a-110n may communicate the data packets as the signals SS_A-SS_N.

The wireless communication devices 112a-112n may be configured to implement one or more wireless data communication protocols. In some embodiments, the wireless communication devices 112a-122n may implement one or more of a Wi-Fi communication protocol, a cellular communication protocol, a BlueTooth communication protocol, a ZigBee communication protocol, a Z-Wave communication protocol, etc. For example, the wireless communication devices 112a-112n may implement one or more of Bluetooth®, ZigBee®, Institute of Electrical and Electronics Engineering (IEEE) 802.11, IEEE 802.11ac, IEEE 802.15, IEEE 802.15.1, IEEE 802.15.2, IEEE 802.15.3, IEEE 802.15.4, IEEE 802.15.5, and/or IEEE 802.20, GSM, CDMA, GPRS, UMTS, CDMA2000, 3GPP LTE, 4G/HSPA/WiMAX, 5G, SMS, etc.

The ECU 104 may comprise a block (or circuit) 120, a block (or circuit) 122, a block (or circuit) 124 and/or a block (or circuit) 126. The circuit 120 may implement an antenna. The circuit 122 may implement a communication device. The circuit 124 may implement an I/O interface. The circuit 126 may implement a decision policy module. The ECU 104 may receive the signals SS_A-SS_N, a signal (e.g., VS_ECU), a signal (e.g., GD_ECU) and/or a signal (e.g., DATA). The ECU 102 may present a signal (e.g., ACT). The ECU 104 may comprise other components (e.g., a microprocessor, random access memory (RAM), read only memory (ROM), etc.) and/or signals (e.g., not shown). The number, type, arrangement and/or implementation of the other components and/or signals of the ECU 104 may be varied according to the design criteria of a particular implementation.

The signal VS_ECU may be a voltage supply for the ECU 104. The signal GD_ECU may be ground connection for the ECU 104. The signal VS_ECU and/or the signal GD_ECU may be received from one of the power taps 54a-54p. The wired connections between the ECU 104 and one of the power taps 54a-54p may be similar to the wired connections implemented for the sensors 102a-102n.

The signal DATA may provide wired sensor data and/or other data to the ECU 104. For example, the I/O interface 124 may be configured to receive data from various sources. In some embodiments, the ECU 104 may be configured to receive the sensor data according to a wired protocol (e.g., the PSI5 standard) and according to the wireless communication from the signals SS_A-SS_N. For example, implementing the wireless communication and the wired protocol using the I/O interface 124 may enable backwards compatibility (e.g., with the PSI5 protocol) for the ECU 104.

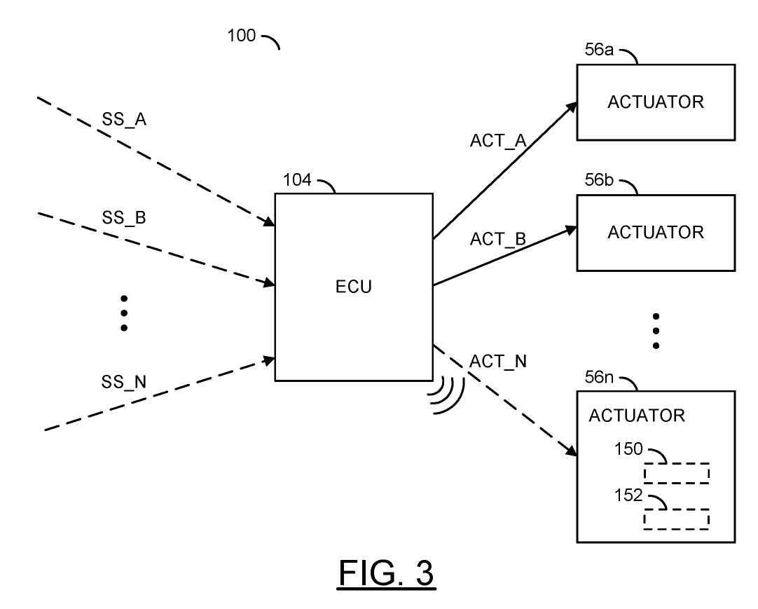

The signal ACT may comprise a number of output signals generated by the ECU 104. The signal ACT may provide instructions to one or more actuators. The signal ACT may be generated to implement the corrective measures. Details of the actuators may be described in association with FIG. 3.

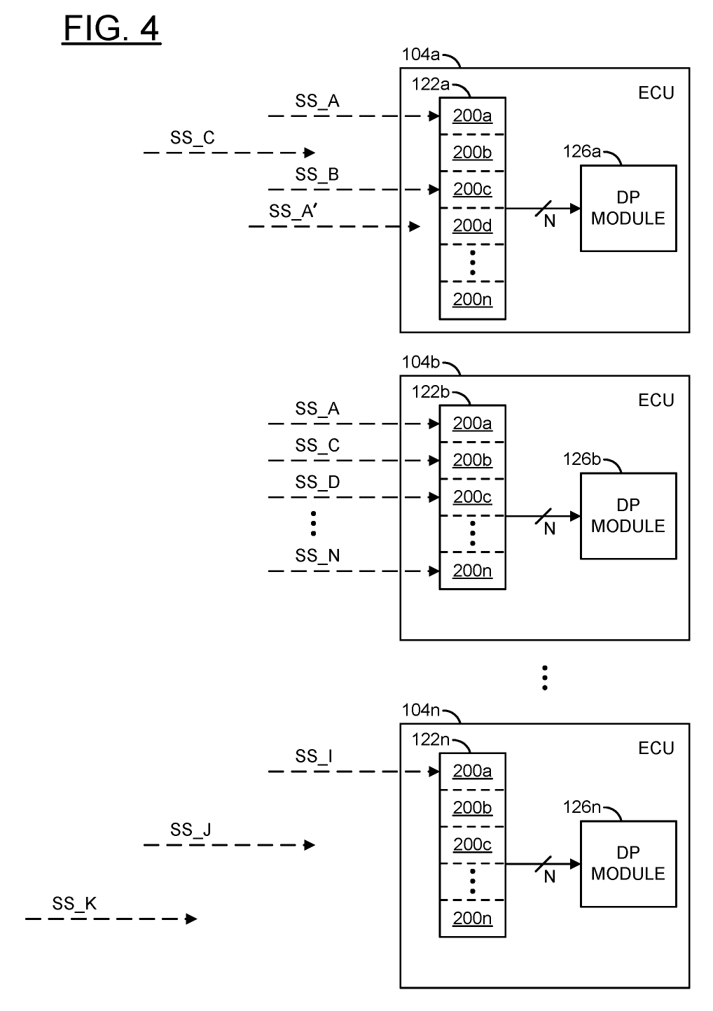

The antenna 120 may be configured to communicate wirelessly. For example, the antenna 120 may receive the signals SS_A-SS_N. The antenna 120 and/or the wireless communication device 122 may be configured to implement the wireless communication. The wireless communication device 122 may be configured to receive the data packets from the sensors 102a-102n via the signals SS_A-SS_N according to one or more wireless protocols. The wireless communication device 122 may be configured to receive the signals SS_A-SS_N asynchronously. The wireless communication device 122 may be configured to provide multi-channel reception of sensor data. Details of the multi-channel reception may be described in association with FIG. 4.

In some embodiments, the antenna 120 and/or the wireless communication device 122 may be configured to transmit data. For example, the ECU 104 may implement handshake and/or security protocols to ensure communication is being performed with one of the sensors 102a-102n that has permission to provide data. In another example, the ECU 104 may be configured to request data from the sensors 102a-102n. In yet another example, the ECU 104 may be configured to implement vehicle-to-vehicle and/or vehicle-to-infrastructure communication.

Referring to FIG. 3, a block diagram illustrating the control unit 104 communicating with actuators is shown. The ECU 104 is shown receiving the signals SS_A-SS_N. The ECU 104 may generate a number of signals (e.g., ACT_A-ACT_N). The ECU 104 is shown connected to a number of blocks (or circuits) 56a-56n. The circuits 56a-56n may implement actuators. The ECU 104 may receive the signals SS_A-SS_N, interpret the sensor data and make one or more decisions. The signals ACT_A-ACT_N may be output signals configured to activate the decisions (e.g., corrective measures) determined by the ECU 104.

The actuators 56a-56n may be components of the vehicle 50 configured to cause an action, move and/or control an aspect of the vehicle 50. The actuators 56a-56n may be configured to perform the corrective measures. For example, the actuators 56a-56n may be one or more of a braking system, a steering system, a lighting system, windshield wipers, a heating/cooling system, an air bag system, etc. In some embodiments, the actuators 56a-56n may be configured to respond to information received from the ECU 104. The ECU 104 may determine desired (e.g., optimum) settings for the output actuators 56a-56n (injection, idle speed, ignition timing, etc.). For example, if the ECU 104 implements a steering system, the ECU 104 may receive one of the signals SS_A-SS_N indicating that a collision with a nearby vehicle is likely and the ECU 104 may respond by generating one or more of the signals ACT_A-ACT_N configured to cause the actuators 56a-56n to change a direction of the vehicle 50 (e.g., a corrective measure).

In another example, if the ECU 104 implements an air bag control system, the ECU 104 may receive one of the signals SS_A-SS_N indicating that a collision has occurred (or is likely to occur) and the ECU 104 may respond by generating one or more of the signals ACT_A-ACT_N configured to cause the actuators 56a-56n to deploy the air bags (e.g., a corrective measure). In advanced air bag systems, the sensors 102a-102n may detect the weight of the occupants, where occupants are seated, and whether the occupants are using a seatbelt. All of the factors detected by the sensors 102a-102n may help the ECU 104 to decide whether and/or how to deploy the actuators 56a-56n (e.g., frontal air bags). The types of actuators 56a-56n implemented may be varied according to the design criteria of a particular implementation.

In some embodiments, the sensors 102a-102n and/or the actuators 56a-56n may be implemented to enable autonomous driving of the vehicle 50. For example, the sensors 102a-102n may receive and/or capture input to provide information about the nearby environment. The information captured by the sensors 102a-102n may be used by components of the vehicle 50 and/or the ECU 104 to perform calculations and/or make decisions. The calculations and/or decisions may determine what actions the vehicle 50 should take. The actions that the vehicle 50 should take may be converted into signals and/or a format readable by the actuators 56a-56n. The actuators 56a-56n may cause the vehicle 50 to move and/or respond to the environment. Other components may be configured to use the data provided by the system 100 to make appropriate decisions for autonomous driving.

In the example shown, the ECU 104 may be connected to the actuators 56a-56n using a wired connection. For example, a wired connection to the actuators 56a-56n may enable a reliable and/or fast data transmission to deploy corrective measures quickly. In the example shown, the communication to the actuator 56a-56n (e.g., the transmission of the signal ACT_N) may be a wireless communication. The actuator 56n is shown comprising a block (or circuit) 150 and/or a block (or circuit) 152. The circuit 150 may implement an antenna. The circuit 152 may implement a wireless communication device. The actuators 56a-56n may comprise other components (not shown). The number, type and/or arrangement of the components of the actuators 56a-56n may be varied according to the design criteria of a particular implementation.

In some embodiments, one or more of the connections between the ECU 104 and the actuators 56a-56n may be the wireless communication. For example, the antenna 150 may have a similar implementation as the antennas 110a-110n implemented by the sensors 102a-102n and/or the antenna 120 implemented by the ECU 104. In another example, the communication device 152 may have a similar implementation as the communication devices 112a-112n implemented by the sensors 102a-102n and/or the communication device 122 implemented by the ECU 104. Similarly, implementing the wireless communication between the ECU 104 and one or more actuators 56a-56n may reduce a complexity of wire routing, reduce a weight of the vehicle 50, enable asynchronous communication of the signals ACT_A-ACT_N and/or enable an increased data rate transfer compared to the wired connections.

The corrective measures may be performed by the actuators 56a-56n. The corrective measures may implement the decisions determined by the ECU 104. The corrective measures may be actions and/or responses. The corrective measures may be real-world (e.g., physical) actions (e.g., movement, audio generation, electrical signal generation, etc.). The corrective measures may comprise the deployment of restraint systems.

Referring to FIG. 4, a block diagram illustrating a multi-channel input for control units is shown. A number of ECUs 104a-104n are shown. In some embodiments, the system 100 may implement multiple ECUs 104a-104n. For example, each of the ECUs may control a different sub-system of the vehicle 50. Each of the ECUs 104a-104n may receive the sensor data from the same sensors 102a-102n, different sensors 102a-102n and/or various groups of the sensors 102a-102n. The inter-connections between the sensors 102a-102n and/or the ECUs 104a-104n may be varied according to the design criteria of a particular implementation.

Each of the ECUs 104a-104n may have an implementation similar to the implementation described in association with FIGS. 1-3. In the example shown, each of the ECUs 104a-104n comprise a respective one of the communication devices 122a-122n and/or a respective one of the decision policy modules 126a-126n. Each of the ECUs 104a-104n may implement other components (not shown). Each of the ECUs 104a-104n may have differing implementations (e.g., differences associated with particular tasks implemented by the ECUs 104a-104n). The number, type and/or arrangement of the ECUs 104a-104n may be varied according to the design criteria of a particular implementation.

The communication devices 122a-122n may implement multi-channel data communication. Each of the communication devices 122a-122n may comprise a number of blocks (or circuits) 200a-200n. The blocks 200a-200n may implement channels for the multi-channel communication. The wireless communication devices 122a-122n may comprise other components (not shown). The number, type and/or arrangement of the channels 200a-200n may be varied according to the design criteria of a particular implementation.

The multi-channel interface 200a-200n may be configured to receive signals in parallel. The multi-channel interface 200a-200n may be configured to receive signals asynchronously. By implementing the multi-channel interface 200a-200n, the system 100 may enable an increased data transfer rate compared to a wired implementation using the PSI5 standard.

In the example shown, the ECU 104a may receive the signals SS_A, SS_B and SS_C. One or more of the signals SS_A, SS_B and SS_C may be received asynchronously. The asynchronous reception may be implemented by enabling each one of the channels 200a-200n to receive one of the signals SS_A-SS_N. In the example shown, the signal SS_A may be received by the channel 200a, the signal SS_C may be received by the channel 200b and the signal SS_B may be received by the channel 200c. In the example shown, the signal SS_A and the signal SS_B may be received at the same time (e.g., in parallel). The signal SS_C may also be received in parallel but may arrive at a later time. In some embodiments, a second signal (e.g., SS_A′) generated by the sensor 102a may be received on one channel (e.g., the channel 200d) while the first signal (e.g., SS_A) generated by the sensor 102a is being received by the channel 200a. The multi-channel interface 200a-200n may enable increased data throughput from the sensors 102a-102n by accepting the sensor data in parallel.

The sensor data received by the channels 200a-200n may be presented to the decision policy modules 126a-126n. Since the sensor data may be received asynchronously, the decision policy modules 126a-126n may perform calculations and/or make decisions as the sensor data is received. The decision policy modules 126a-126n may not have to wait until all of the sensor data is received before firing (e.g., generating one or more of the signals ACT_A-ACT_N). In an example, if the signals SS_A and SS_E provide sufficient data for the decision policy module 126a to determine that a collision has occurred, the decision policy module 126a may generate an output signal (e.g., one or more of the signals ACT_A-ACT_N) to deploy air bags (e.g., a corrective measure) without waiting for all the signals (e.g., the signal SS_C) to arrive.

In the example shown, the ECU 104b may receive the signals SS_A-SS_N in parallel. For example each of the channels 200a-200n may receive a respective one of the signals SS_A-SS_N. The communication devices 112a-112n and the communication devices 122a-122n may be configured to establish a communication link to ensure that each of the signals SS_A-SS_N are received by one of the channels 200a-200n. For example, a handshake protocol (e.g., the Autostar E2E protocol) may be implemented to ensure that data packets are not lost, that each of the signals SS_A-SS_N are received by an appropriate one of the channels 200a-200n and/or that the wireless communication devices 112a-112n have permission to write to the channels 200a-200n.

In the example shown, the ECU 104n may receive the signals SS_I-SS_K. The signals SS_I-SS_K may each arrive at the ECU 104n at a different time. For example, the signal SS_I may be received by the channel 200a first, then the signal SS_J may be received by the channel 200c and the signal SS_K may be received by the channel 200n last. The sensors 102a-102n may be configured to generate time stamps for the signals SS_A-SS_N. The time stamps may indicate when the sensor data was read by the sensors 102a-102n. The ECUs 104a-104n may be configured to read the time stamps to determine a temporal order of the received sensor data.

The time stamps may be used by the ECUs 104a-104n to correlate the time that the data was read by the sensors 102a-102n with the asynchronous reception of the signals SS_A-SS_N. The time stamps in the signals SS_A-SS_N may be used to counter data skew. In the example shown, the signal SS_K may be comprise data that was read at the same time as the sensor data in the signal SS_I even though the signal SS_I may be received earlier (e.g., the sensor 102i may be physically located closer to the ECU 104n than the sensor 102k). The time stamps may ensure that the decision policy module 126n models the environment for a particular time using the sensor data from the signal SS_I and the signal SS_K.

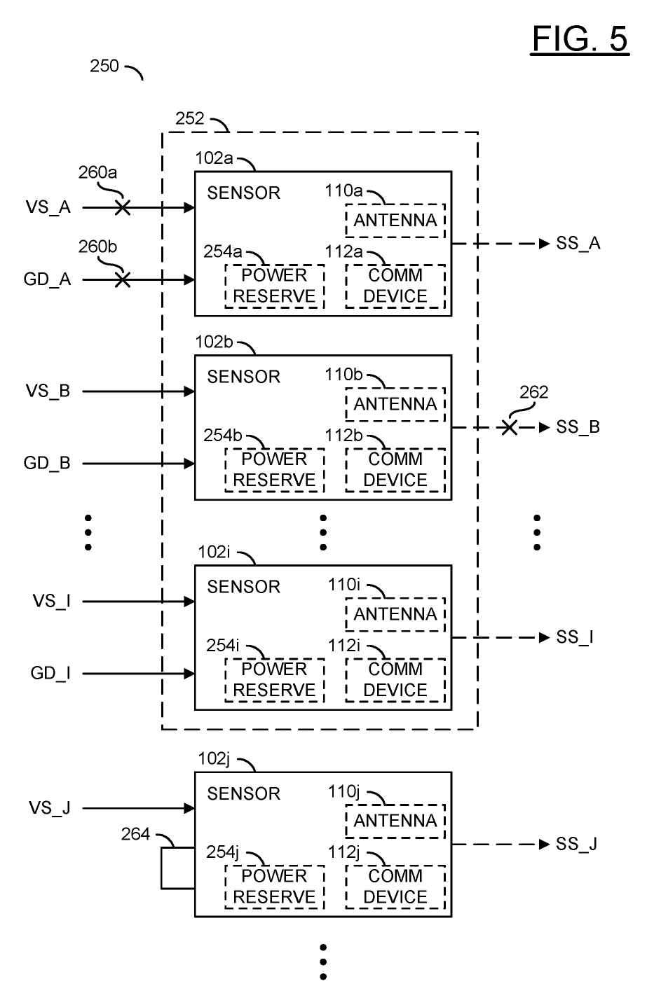

Referring to FIG. 5, a block diagram 250 illustrating a redundant sensor implementation is shown. Implementing the wireless communication may enable the system 100 to provide easy sensor failover. The redundant sensor implementation 250 may comprise the sensors 102a-102j. The sensors 102a-102i may be implemented as a redundant sensor block 252. The sensors 102a-102i in the redundant sensor block 252 may provide the same and/or similar functionality. In one example, each of the sensors 102a-102i may implement a gyroscope and/or magnetometer. In some embodiments, each of the redundant sensors 102a-102i in the redundant sensor block 252 may be located in different locations of the vehicle 50. The implementation of the redundant sensor block 252 may be varied according to the design criteria of a particular implementation.

The sensor failover implemented by the system 100 may enable any one of the sensors 102a-102i in the redundant sensor block 252 to provide data to the ECU 104. In one example, the sensor 102a may provide the sensor data to the ECU 104. If the sensor 102a becomes disabled, then another sensor (e.g., the sensor 102b) may provide the sensor data to the ECU 104. Using the wireless communication may enable any of the redundant sensors 102a-102i to replace another of the redundant sensors 102a-102i. The failover between the redundant sensors 102a-102i may be seamless since wiring may not need to be replaced and/or re-routed.

In some embodiments, the sensors 102a-102j may each comprise a corresponding block (or circuit) 254a-254j. The blocks 254a-254j may implement a power reserve. Generally, the sensors 102a-102j may receive the power supply from the power taps 54a-54p. The power reserves 254a-254j may provide a backup and/or alternate power storage. In one example, the power reserve 254a-254j may be a battery (e.g., a lithium ion type battery). However, the sensors 102a-102j may have an operating life of 20 years or more and replacing a battery may be difficult. In another example, the power reserves 254a-254j may be a capacitor (e.g., a super-capacitor). The technology used to implement the power reserves 254a-254j may be varied according to the design criteria of a particular implementation.

The power reserves 254a-254j may provide backup power when a default power supply is unavailable. Interrupts 260a-260b are shown. The interrupts 260a-260b may be located on the supply lines VS_A and GD_A for the sensor 102a. The interrupts 260a-260b may represent an interruption of the power supply to the sensor 102a. In one example, the power supply lines may have been severed. The power reserve 254a may enable the sensor 102a to operate for an amount of time after the default power supply has become unavailable. For example, in a collision scenario, damage to the vehicle 50 may disable power supply from the battery 52. The sensors 102a-102j may continue to send data to a corresponding one of the ECUs 104a-104n while the power reserves 254a-254j provide power.

In some embodiments, the ECU 104 may receive the sensor data from each of the sensors 102a-102i of the redundant sensor block 252. For example, the ECU 104 may be configured to compare the sensor data from each of the sensors 102a-102n to ensure each of the sensors 102a-102n are reading accurately. In the example shown, noise 262 is shown on the wireless signal SS_B. The noise 262 may represent a corruption of the sensor data generated by the sensor 102b. For example, the sensor 102b may be damaged and provide data results that are much different than the rest of the redundant sensors 102a-102i. If the ECU 104 determines one of the redundant sensors 102a-102i is providing bad data, the sensor (e.g., the sensor 102b) may be ignored. In some embodiments, one of the corrective measures implemented by the ECU 104 may be to initiate a re-calibration of the sensor providing inaccurate data.

A mounting 264 is shown on the sensor 102j. The mounting 264 may be implemented to mount the sensor 102j to the body of the vehicle 50. In some embodiments, the mounting 264 may provide a ground connection for the sensor 102j. When the sensor 102j has a ground provided by the mounting 264, only one wire may be used to provide the supply power VS_J (e.g., a second wire for the ground GD_J is not needed).

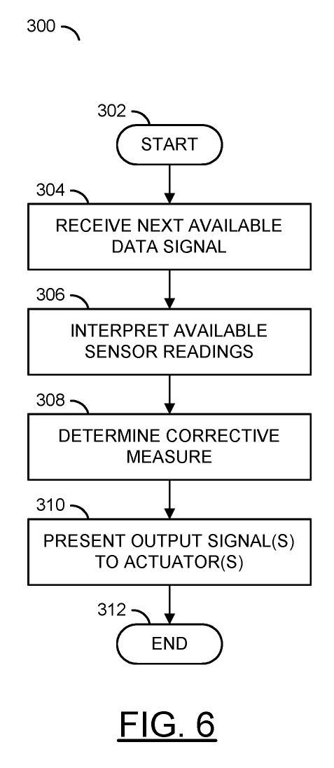

Referring to FIG. 6, a method (or process) 300 is shown. The method 300 may fire a corrective measure as soon as sufficient sensor data is received. The method 300 generally comprises a step (or state) 302, a step (or state) 304, a step (or state) 306, a step (or state) 308, a step (or state) 310, and a step (or state) 312.

The step 302 may start the method 300. In the step 304, the ECU 104 may receive a next one of the available sensor data signals SS_A-SS_N from the sensors 102a-102n. For example, the next one of the signals SS_A-SS_N may be received by an available channel 200a-200n. Next, in the step 306, the decision policy module 126 may interpret the available sensor readings. Next, the method 300 may move to the step 308.

In the step 308, the ECU 104 may determine the corrective measure. For example, the ECU 104 may decide an appropriate corrective measure to apply to the scenario determined in the data model. Next, in the step 310, the ECU 104 may present the output signals ACT_A-ACT_N to the actuators 56a-56n. The actuators 56a-56n may perform the corrective measure. Next, the method 300 may move to the step 310. The step 310 may end the method 300.

The system 100 enables the sensor data to be received asynchronously by the ECU 104. The ECU 104 may begin evaluating the sensor data from the first sensor data received. For example, in a collision scenario, a first of the sensors 102a-102n may transmit the signal SS_A. The ECU 104 may evaluate the signal SS_A while receiving the other sensor data. For example, if the sensor data SS_A provides sufficient information to determine that an air bag deployment is desirable, then the ECU 104 may generate the signals ACT_A-ACT_N (e.g., to initiate the air bag inflators) before the other data signals SS_B-SS_N are received and/or processed. For an example where the actuators 56a-56n activate air bags, data from 10 of the sensors 102a-102n may be used before deployment. Instead of waiting for each of the sensors 102a-102n to send data before making a decision and/or received according to the PSI5 standard (e.g., serially), the sensors 102a-102n may send the sensor data in parallel, and the ECU 104 may make a decision faster since all the data may be available at once.

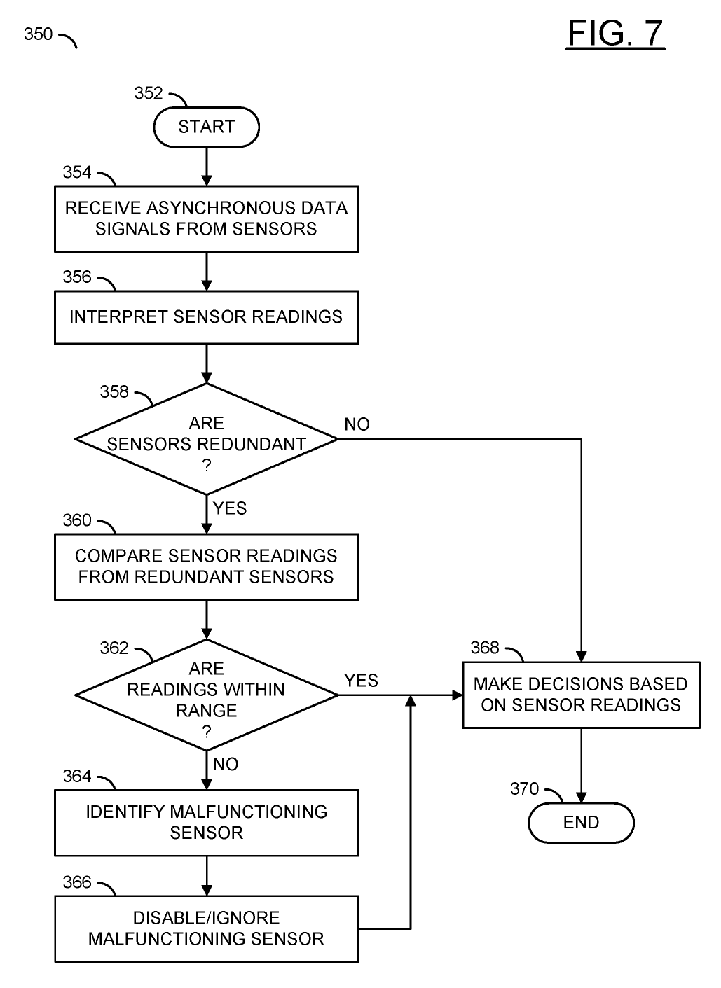

Referring to FIG. 7, a method (or process) 350 is shown. The method 350 may disable a malfunctioning sensor. The method 350 generally comprises a step (or state) 352, a step (or state) 354, a step (or state) 356, a decision step (or state) 358, a step (or state) 360, a decision step (or state) 362, a step (or state) 364, a step (or state) 366, a step (or state) 368, and a step (or state) 370.

The step 352 may start the method 350. In the step 354, the ECU 104 may receive asynchronous data from the sensors 102a-102n. Next, in the step 356, the ECU 104 may interpret the sensor readings (e.g., the data provided by the signals SS_A-SS_N). Next, the method 350 may move to the decision step 358.

In the decision step 358, the ECU 104 may determine whether the sensors are redundant. For example, the sensors 102a-102i within the redundant sensor block 252 shown in association with FIG. 5 may be redundant. If the sensors are not redundant, the method 350 may move to the step 368. If the sensors are redundant, the method 350 may move to the step 360. In the step 360, the ECU 104 may compare the sensor readings from the redundant sensors. Next, the method 350 may move to the decision step 362.

In the decision step 362, the ECU 104 may determine whether the readings from the redundant sensors are within range. For example, the ECU 104 may store a pre-defined expected range that all of the redundant sensors should be within. Any of the redundant sensors that are outliers of the range may be malfunctioning. If the readings are within range, the method 350 may move to the step 368. If the readings are not within range, the method 350 may move to the step 364.

In the step 364, the ECU 104 may identify which of the redundant sensors is malfunctioning (e.g., the outlier). Next, in the step 366, the ECU 104 may disable and/or ignore the malfunctioning sensor. For example, one of the signals ACT_A-ACT_N may be used to disable the malfunctioning sensors (e.g., one of the actuators 56a-56n may be a component of the sensors 102a-102n). Next, the method 350 may move to the step 368. In the step 368, the ECU 104 may make decisions based on the sensor readings. Next, the method 350 may move to the step 370. The step 370 may end the method 350.

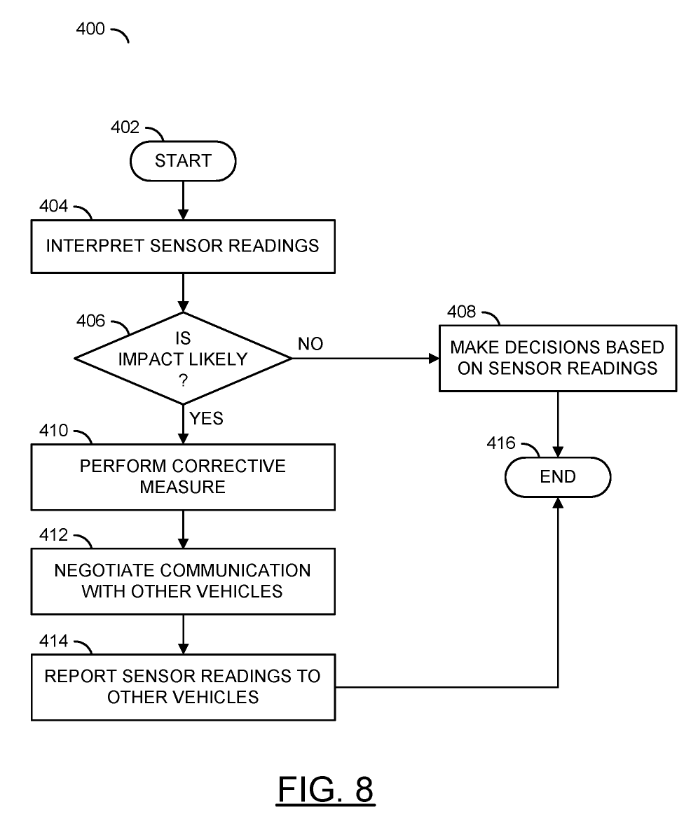

Referring to FIG. 8, a method (or process) 400 is shown. The method 400 may communicate with control units of other vehicles. The method 400 generally comprises a step (or state) 402, a step (or state) 404, a decision step (or state) 406, a step (or state) 408, a step (or state) 410, a step (or state) 412, a step (or state) 414, and a step (or state) 416.

The step 402 may start the method 400. In the step 404, the ECUs 104a-104n may interpret the sensor readings SS_A-SS_N. Next, the method 400 may move to the decision step 406. In the decision step 406, the ECUs 104a-104n may determine whether an impact is likely. If the impact is not likely, the method 400 may move to the step 408. In the step 408, the ECU 104 may make decisions based on the sensor readings. Next, the method 400 may move to the step 416.

In the decision step 406, if the impact is likely, the method 400 may move to the step 410. In the step 410, the ECUs 104a-104n may perform one or more of the corrective measures. Next, in the step 412, the wireless communication devices 122a-122n may negotiate communication with other vehicles. For example, communication may be established with nearby vehicles. In the step 414, the ECUs 104a-104n may report sensor readings to the other vehicles. Next, the method 400 may move to the step 416. The step 416 may end the method 400.

The ECUs 104a-104n may be configured to communicate with other vehicles (e.g., ECUs implemented in other vehicles). For example, each of the ECUs 104a-104n may communicate with ECUs of another vehicle that analyze the same type of data and/or make the same type of decisions. In some embodiments, a communication protocol may be established and/or permissions may be granted for the wireless communication between vehicles. In some embodiments, an alert may be presented by the ECUs 104a-104n to any vehicle that is listening. In some embodiments, the ECUs 104a-104n may follow protocols associated with vehicle-to-vehicle and/or vehicle-to-infrastructure (V2X) communication. Communicating with the other vehicles may provide a richer data set to enable other vehicles to react. For example, if the vehicle 50 is braking quickly, communicating the rapid deceleration to another vehicle may provide additional information to enable other vehicles to react (e.g., perform a corrective measure).

In some embodiments, the sensors 102a-102n may be satellite sensors implemented around a periphery of the vehicle 50. The sensors 102a-102n may implement remote satellite sensors (e.g., impact sensors) around the perimeter of the vehicle 50. For example, approximately 5 to 20 of the sensors 102a-102n may be installed in and/or on the vehicle 50.

The system 100 may reduce a weight, routing and/or space used for wire harnessing in vehicles compared to wired protocols such as PSI5. Reducing the weight of the harnessing of the vehicle 50 may reduce emissions. The wireless communication may reduce radiated EMC cross-talk and/or improve data integrity. Since the system 100 implements two wires to supply power (or one when the mount 264 is implemented), the ECU 104 may not be implemented with pins for sensor input (or a reduced amount of input pins). For example, the multi-channel interface 200a-200n may replace and/or supplement data input pins.

The asynchronous data communication implemented by the system 100 may avoid the problem of data skew. Since the sensors 102a-102n may be located in various portions of the vehicle 50, there may be different distances between the sensors 102a-102n and the ECU 104. With a wired protocol for sensor data communication, such as PSI5, different wire lengths may result in sensor data being received by the ECU 104 at different times (e.g., data skew). The system 100 may eliminate and/or replace circuitry used to condition wired data input to eliminate the data skew. For example, the time stamps provided with the signals SS_A-SS_N may enable the ECU 104 to arrange the sensor data temporally (e.g., sensor data corresponding to a same time frame may be analyzed together).

The system 100 may implement a wireless link for sensor data and wired connections only for power. For example, the wireless link may be implemented between the wireless communication devices 112a-112n of the sensors 102a-102n and the wireless communication devices 122a-122n of the ECUs 104a-104n. Implementing the wireless communication may enable higher sampling rates for sensor data than using the PSI5 protocol. In one example, the sensors 102a-102n may present the sensor data at a rate of approximately 2 MHz. For example, the system 100 may implement an IEEE 802.11ac and/or 802.11b wireless communication protocol, which has been approved for automotive use. The increased sampling rate of the system 100 may enable faster and/or richer data readings/sampling. A faster data transfer may enable a reduced restraint deployment time (e.g., faster deployment of the corrective measures). In one example, the firing time may be reduced by approximately 1.5 ms. For example, implementing the system 100 may enable an increased rate of fire for the actuators 56a-56n (e.g., a 10 ms-20 ms time to fire for air bags).

The system 100 may be implemented without a wired data connection between the sensors 102a-102n and the ECU 104. The sensors 102a-102n may be powered by connections to the power taps 54a-54p (e.g., a nearby power supply such as taking one wire from a window motor). In some embodiments, the power taps 54a-54p may be provided from one of the ECUs 104a-104n (e.g., one of the sensors 102a-102n may tap into power from one of the ECUs 104a-104n even if the particular sensor does not provide data to the particular ECU) . Since the sensors 102a-102n do not have a wired connection to the ECU 104 a constant 25 mA loop for each sensor may be eliminated. For example, the sensors 102a-102n may operate in a low powered state when not communicating data to reduce power. Eliminating a constant current loop between the sensors 102a-102n and the ECU 104 by using the wireless communication, the overall power demand of the vehicle 50 may be reduced. The power reserves 254a-254n may enable sensor operation after power loss.

Radio frequency (RF) links may be established between the vehicle 50 and other vehicles (e.g., V2X communication). Using the wireless connection, the system 100 may enable inter-vehicle signaling. The implementation of V2X communication may be varied according to the design criteria of a particular implementation.

The system 100 may provide more detailed data and/or enable a shortened deployment decision time. Since the system 100 enables a wireless programming of the satellite sensors 102a-102n, the sensors 102a-102n may be tested remotely (e.g., wireless diagnostics testing). The reduced pin count, weight, wire routing and/or harness weight may reduce costs.

The wireless communication implemented by the system 100 may enable asynchronous communication of the sensor data. With the asynchronous wireless communication, the sensor data communication many not need to be initiated by the ECUs 104a-104n (e.g., no sync pulse before data communication). The asynchronous communication may enable the sensors 102a-102n to communicate using different data rates. The asynchronous communication may implement multiple wireless communication channels. The sensor data may be time stamped and/or buffered using the multi-channel interface 200a-200n. The data policy module 126 may organize the asynchronous data to generate a data model of what is happening around and/or within the vehicle 50. With the faster data reception by the ECU 104, more time may be available to properly form the data model. A properly formed data model (e.g., a richer data set) may enable improved decision-making.

The asynchronous wireless data communication may comprise data being sent over multiple channels. Data from the various sensors 102a-102n may be sent and/or received at different times and/or rates. Asynchronous wireless data communication may enable the sensor data to be communicated in parallel. Asynchronous wireless data communication may enable multiple communication protocols to be implemented at the same time. For example, each of the channels 200a-200n may implement different wireless communication protocols. The ECU 104 may receive data from the sensors 102a-102n asynchronously. The timing of the reception of the sensor data may be different and the ECU 104 may be configured to arrange the sensor data according to the time that the sensor data was read by the sensors 102a-102n. For example, the asynchronous communication may enable first in first out processing of the sensor data.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. A system comprising:
a plurality of sensors each (a) comprising a communication device and (b) configured to (i) monitor information corresponding to a vehicle, (ii) generate data signals in response to said information and (iii) communicate said data signals; and
a control unit configured to (i) receive said data signals from each of said sensors, (ii) interpret said data signals, (iii) determine a corrective measure in response to said data signals and (iv) generate output signals, wherein (a) said communication device implements wireless communication, (b) said control unit receives said data signals wirelessly and (c) said wireless communication enables said control unit to receive said data signals from said plurality of sensors asynchronously.

2. The system according to claim 1, wherein said control unit comprises a multi-channel input interface configured to receive said data signals asynchronously.

3. The system according to claim 1, wherein each of said sensors comprise a wired connection to a power source.

4. The system according to claim 3, wherein (i) said vehicle provides a plurality of power sources and (ii) one or more of said sensors receive power from a nearest one of said power sources.

5. The system according to claim 3, wherein said wired connection to said sensors is only used for power.

6. The system according to claim 1, wherein said wireless communication transmits said data signals faster than a wired protocol.

7. The system according to claim 6, wherein implementing said wireless communication reduces a power demand compared to said wired protocol.

8. The system according to claim 6, wherein said wired protocol is a Peripheral Sensor Interface 5 (PSI5) standard.

9. The system according to claim 6, wherein implementing said wireless communication reduces at least one of (a) a weight and (b) a wire routing complexity for communicating said data signals compared to said wired protocol.

10. The system according to claim 1, wherein said wireless communication prevents crosstalk when communicating said data signals.

11. The system according to claim 10, wherein preventing said crosstalk improves a data integrity of said data signals.

12. The system according to claim 1, wherein said wireless communication is implemented according to at least one of a 802.11ac protocol, a 802.11b protocol, a Bluetooth protocol, a ZigBee protocol and a Z-Wave protocol.

13. The system according to claim 1, wherein said wireless communication enables transmission of said data signals at a rate of approximately 2 MHz.

14. The system according to claim 1, wherein said output signals are presented to one or more actuators configured to perform said corrective measure.

15. The system according to claim 1, wherein said sensors (i) implement peripheral satellite sensors for said vehicle and (ii) are configured to detect an impact.

16. The system according to claim 1, wherein each of said sensors is configured to initiate said wireless communication of said data signals to said control unit.

17. The system according to claim 1, wherein said wireless communication reduces a number of input pins for said control unit.
